(19) United States
(12) Patent Application Publication
(10) Pub. No.: US 2009/0225728 A1
(43) Pub. Date: Sep. 10, 2009

(54) Analogue Beamforming

(76) Inventors: Zhifeng Tao, Allston, MA (US); Andreas F. Molisch, Pasadena, CA (US); Philip V. Orlik, Cambridge, MA (US); Jinyun Zhang, Cambridge, MA (US); Toshiyuki Kuze, Hiratsuka (JP)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/358,467

(22) Filed: Jan. 23, 2009

Related U.S. Application Data
(60) Provisional application No. 61/035,123, filed on Mar. 10, 2008.

(51) Int. Cl. H04B 7/212; H04W 4/00

(52) U.S. Cl. 370/337; 370/338

(57) ABSTRACT

An orthogonal frequency division multiple access (OFDMA) network including a base station (BS) associated with a set of mobile stations (MS) in a cell. The set of MS are grouped into sets of active MS, wherein each set of active MS corresponds to a beam formed at the BS. The BS transmits a down link (DL) subframe using analog beam forming (ABF), wherein the DL subframe has one ABF zone for each set of active MS and each corresponding beam.

### RELATED APPLICATION

This patent application claims priority to Provisional Application 61/035,123, “Analogue Beamforming,” filed by Kuze et al. on Mar. 10, 2008, incorporated herein by reference.

### FIELD OF THE INVENTION

This invention relates generally to wireless networks, and more particularly to analog beam forming and beam switching in networks according to the IEEE 802.16m standard.

### BACKGROUND OF THE INVENTION

One object of networks designed according to the Worldwide Interoperability for Microwave Access (WiMAX) standard is to improve a spectral efficiency of networks, while keeping the cost of deployments to a minimum. Fixed WiMAX is based on the IEEE 802.16d standard, and mobile WiMAX on the IEEE 802.16e standard.

One way to do this is to use analog beam forming (ABF). The BS can switch arbitrarily through the available beams on the up link and the down link and communicates with the MS located in the active beams. The range of the cell is extended by the beam forming, which is important especially in rural areas. By adopting appropriate beam switching patterns, the interference can also be reduced.

Analog beam forming (ABF) is not the theoretic optimal way of using multiple antenna elements. Heterodyning all the signals to and from the baseband, and digitally processing the signals can achieve a higher capacity; see U.S. Pat. No. 6,307,506, “Method and apparatus for enhancing the directional transmission and reception of information.” However, ABF presents an excellent tradeoff between performance and complexity. For example, ABF can be performed with only a single radio frequency (RF) chain.

As another advantage, ABF can be combined with spatial multiplexing and other MIMO techniques. The set of N available antenna elements can be partitioned into K groups of M antennas, i.e., M×K=N, so that K beams are formed. In each beam, M antenna elements are available for spatial multiplexing. When dual-polarized antennas are used.

The IEEE 802.16 standards define a frame for the down link (DL) and up link (UL). The various fields and zones are described in complete detail in IEEE 802.16 standard “Part 16: Air interface for Broadband Wireless Access Systems,” and U.S. Publication 2008-0165881, “Method for Accessing Channels in OFDMA Mobile Multihop Relay Networks,” Tao et al.

FIG. 1 shows the conventional frame, which includes a DL subframe, and a UL subframe. The first symbol transmitted by the base station in the DL subframe is a preamble. The preamble enables the mobile stations to perform synchronization and channel estimation.

The frame includes a sequence of OFDM symbols, denoted in the horizontal time direction, and is indexed with integer k, {k, k+1, k+2, . . . , K}. Each OFDM symbol also includes a number of sub-channels, denoted in the vertical direction, and indexed with the integer, s {s, s+1, s+2, . . . , S}.

The first subchannel in the first two OFDMA symbols in the down link is the frame control header (FCH). The FCH is transmitted using QPSK rate 1/2 with four repetitions. The FCH specifies a length of the immediately succeeding down link MAP (DL-MAP) message and the repetition coding used for DL-MAP.

The BS uses the down link MAP (DL-MAP) and an up link MAP (UL-MAP) message to notify MS of the resources allocated to data bursts in the down link and up link direction, respectively, within the current frame. The bursts are associated with connection identifiers (CID).

Based upon a schedule received from the BS, each MS can thus determine when (i.e., OFDMA symbols) and where (i.e., subchannels) the MS should transceive (transmit or receive) with the BS. The first subchannels 203 in the UL subframe are used for ranging.

The receive/transmit gap (RTG) separates the frames, and the transmit transition gap (TTG) separates the subframes within a frame. This enables the transceivers to switch between transmit and receive modes.

However, that frame does not have zones to support ABF.

### SUMMARY OF THE INVENTION

An orthogonal frequency division multiple access (OFDMA) network including a base station (BS) associated with a set of mobile stations (MS) in a cell.

The set of MS are grouped into sets of active MS, wherein each set of active MS corresponds to a beam formed at the BS.

The BS transmits a down link (DL) subframe using analog beam forming (ABF), wherein the DL subframe has one ABF zone for each set of active MS and each corresponding beam.

### BRIEF DESCRIPTION OF THE DRAWINGS

FIG. 1 is a block diagram of a conventional superframe structure;

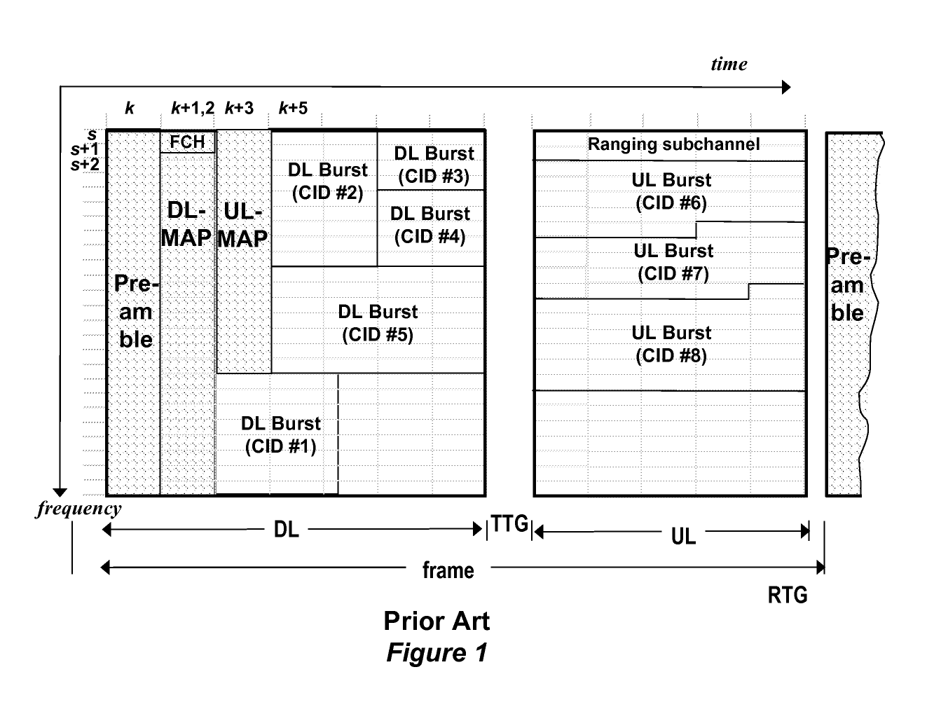

FIG. 2 is a schematic of a wireless network according to embodiments of the invention; and

FIG. 3 is a block diagram of a superframe according to embodiments of the invention;

FIG. 4 is a schematic of beam switching according to embodiments of the invention; and

FIG. 5 is a graph comparing networks with and without beam forming.

### DETAILED DESCRIPTION OF THE PREFERRED EMBODIMENT

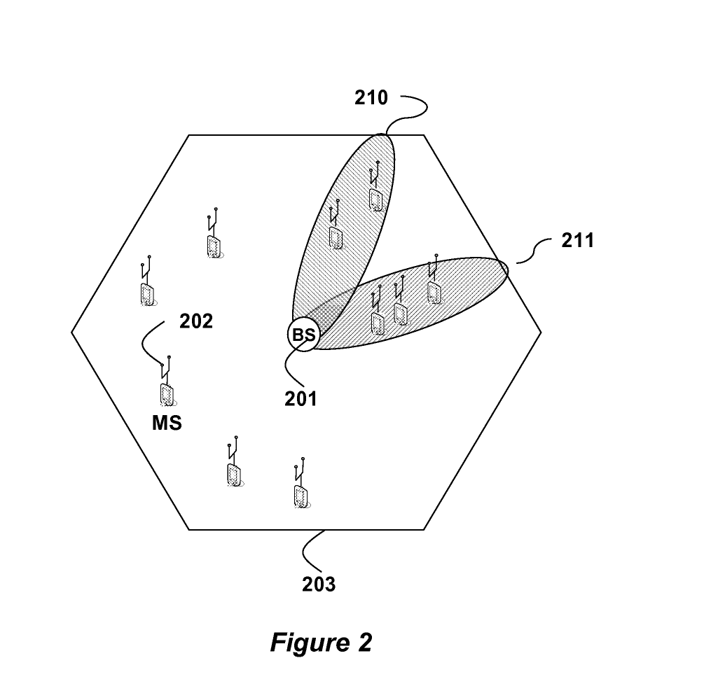

FIG. 2 shows a wireless network with a base station (BS) 201, and a set of mobile stations (MS) 202 according to embodiments of our invention. The BS can form beams 210-211 within the cell 203 using a linear antenna array concatenated with a Butler matrix, see U.S. Patent Application 20060104197, “Method and system for economical beam forming in a radio communication system.”

Analog beam forming (ABF) requires that we define new zones in the superframe structure for the down link (DL) and the up link (UL). A zone is a time division duplexing technique that allows multiple transmission formats in the same DL and UL.

By partitioning the DL into multiple zones, the MS in different zones can be handled sequentially. Each ABF zone corresponds to a transmission interval in the DL, where a particular beam is active at the BS. Thus, the MS within the geographic coverage area of the active beam are grouped into an active set, and served during the corresponding zones.

The embodiment of the invention enable an efficient grouping of the MS into the active sets for the corresponding beams, and then serving all MS within each active set during the same zone of the DL or UL sub-frame.

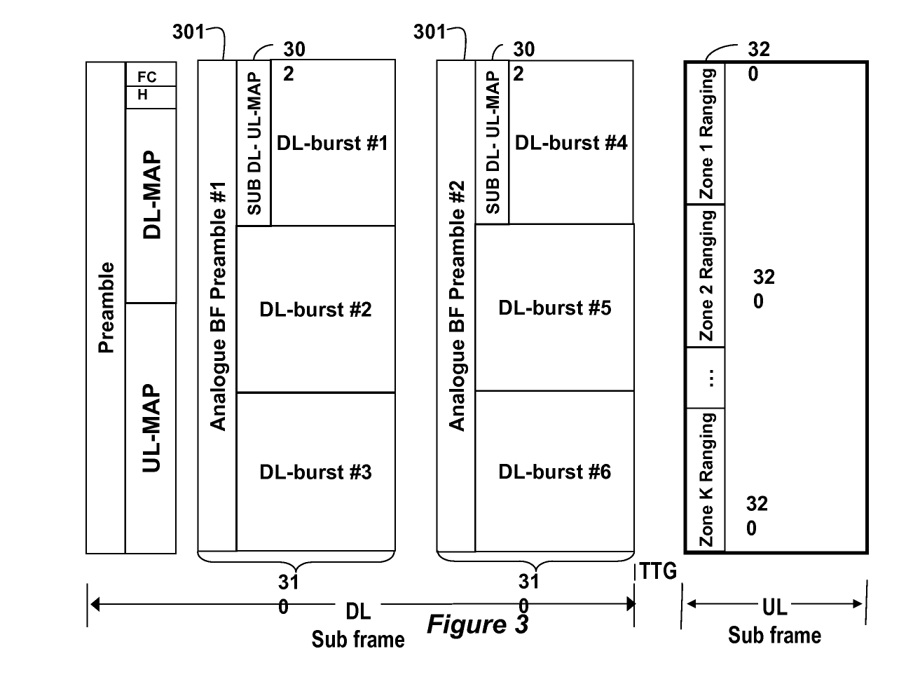

FIG. 3 shows the frame structure according to embodiments of the invention. The DL subframe is partitioned into K ABF zones 310. There is one zone for each of the two ABF zones. There is a preamble 301 at the beginning of each AFB zone 310. The MS detect which preamble has the highest signal strength. This enables the MS to associate with the beam that has the best signal-to-interference ratio (SINR).

When ABF is used with FIG. 3 shows more details of the frame structure when BF is used with adaptive modulation and coding (AMC). When ABF is used with full usage of subchannels (FUSC) and partial usage of subchannels (PUSC), advanced audio coding conventional (AAS) zones can be used.

The conventional DL-MAP includes the information about the ABF zones and the location (in the time-frequency domain) of the preamble 301 of each zone 310.

Additionally, each zone has a UL-DL compressed map 302. The map indicates the location of the subsequent UL ranging region 320. The ranging regions are located in the UL subframe. The MS use these regions to signal to the BS that the MS is to be served in the associated DL zone.

During the initial reception of the ABF preambles 301, each MS tries to detect the zone preamble. If the MS detects a certain zone preamble, then the MS can decode the UL-DL compressed map.

During the next UL subframe, the MS starts a ranging process by using in the ranging region indicated in the UL-DL compressed map. The MS can perform ranging for each analog BF preamble during the DL subframe. The MS transmit the ranging data to the BS, and the BS selects the active MS sets using the ranging data.

Interference Reduction with ABF

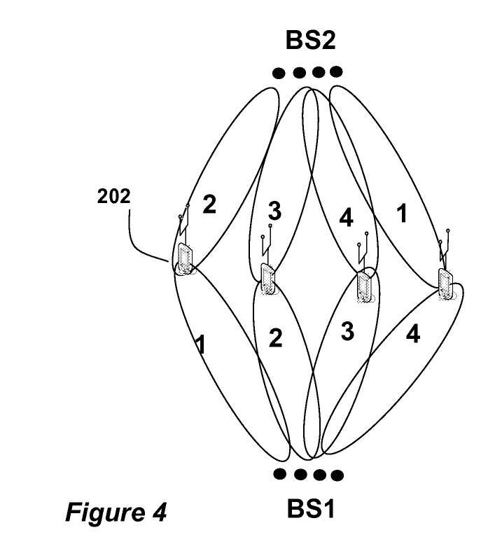

As shown in FIG. 4, ABF can also be used to reduce interference. The MS in different beams 1-4 are served at different times. Therefore, if BS1 and BS2 in adjacent cells arrange the down link transmission in such a way that the transmissions do not transmit to the same part of a cell edge at the same time, and similarly for the up link, then the interference at the MS is greatly reduced.

If the BS can coordinate the beams, then interference from adjacent cells can be almost completely eliminated, and only second-tier interference remains. If the BS cannot coordinate their beam switching, then the sequence in which beams are served can be selected randomly, and independently at each BS. This still leads to a stochastic reduction of the interference, similar to the reduction of interference in random frequency hopping or time-hopping impulse radio.

The hopping sequence can be determined at each BS, based on a base station identification (BS_ID). For example, the BS_ID is used as an initial value, i.e., seed, to a feedback shift register that generates a random hopping sequence.

Training for ABF

As described above, each zone has its own preamble that enables the MS to determine which beam is best. This requires that the MS receives all ABF preambles. A suboptimum solution is that the MS only receive the beams that are adjacent to the beam used for current communications. Additionally, it is not necessary for the MS to receive adjacent preambles during each frame. The time that the MS stays within one beam is usually quite large, on the order of seconds, so that infrequent listening is sufficient. If the MS is fixed, the detecting needs to perform again only when the MS moves.

For the up link, the MS can, from time to time, transmit the ranging signals in the zones associated with beams adjacent to the current beam. The periodic ranging is arranged so that collisions of the MS signal with that of other ranging signals are minimized. This is arranged by the BS, which controls the UL ranging through the UL map.

Feedback for Beam Scheduling

It may be helpful to let MS feedback to the BS the index of the best beam receives. The BS can use this feedback information to perform beam scheduling. With AMC, the feedback from the MS includes a channel quality indication for different beams for all the subchannels. This can further enable frequency and beam scheduling.

Performance for Training Structure for Basic Case

To test the performance enhancement achievable with ABF, we have simulated a small WiMAX network. We consider the down link case, and the average signal to interference and noise ratio (SINR) cumulative distribution function (CDF) at the simulated MS. To generate the CDF, a MS is randomly placed in a sector of interest. We assume that the MS communicates on the best available beam from the base station. The base station may communicate on N_{B} beams, where N_{B} is assumed to be either four or eight.

Each of the adjacent sectors interferers directly, i.e., the active beam from the adjacent sector are directed at the MS, with probability 1/N_{B}. In this case, the interference from the adjacent sector is large. In the case when no direct interference is present from the adjacent sector, then a random beam, not directed at the MS, is assumed to be active, and the interference contribution from this sector is computed assuming a transmission from this sector.

The receiver noise is assumed to be additive white Gaussian (AWG). The SINR is determined at a thousand random locations within the sector. At each location five channel realizations are averaged to determine the SINR at each location. Other simulation assumptions are in Table 1.

TABLE

| | |
|---|---|
| Fast Fourier Transform size | 1024 |
| Bandwidth | 10 MHz |
| Channel model | Urban Macro |
| Center Frequency | 2.5 GHz |
| Inter site distance | 1000 m |
| Thermal noise | −203 dBW/Hz |
| Receiver Noise Figure | 7 dB |

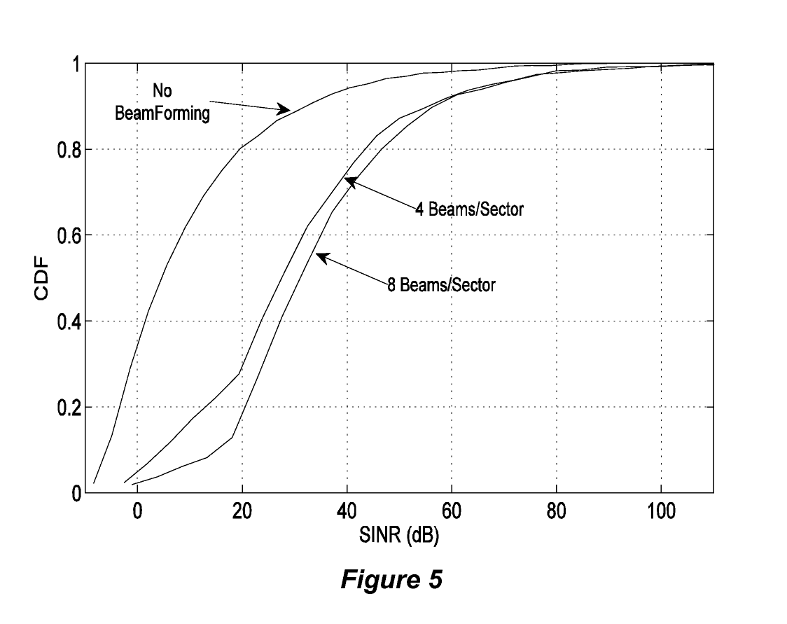

The results are shown in FIG. 5. There is a significant improvement in the SINR with ABF. For a four beam network, the gain is approximately 22 dB at the median of the CDF. An additional 3 dB gain can be achieved with eight beams.

### EFFECT OF THE INVENTION

The invention provides a simple but extremely efficient method for increasing SINR, and thus throughput in WiMAX networks. The method is not the optimum way of exploiting multiple antenna elements. A four-beam switching network cannot perform as well as a full four-antenna MIMO networks. However, the complexity of a four-beam switching network is much lower than a four-antenna MIMO network.

The complexity is identical to that of a single-antenna network with a single FRF chain, and just an additional switch and four antennas. Beam switching provides a low-cost and efficient solution both for range extension and for interference reduction.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for communicating in an orthogonal frequency division multiple access (OFDMA) network including a base station (BS) associated with a set of mobile stations (MS) in a cell, comprising:
grouping the set of MS into sets of active MS, wherein each set of active MS corresponds to a beam formed at the BS; and
transmitting, by the BS, a down link (DL) subframe using analog beam forming (ABF), wherein the DL subframe has one ABF zone for each set of active MS and each corresponding beam.

2. The method of claim 1, wherein the DL subframe includes an ABF preamble, and further comprising:
detecting at each MS the ABF preamble for each beam to determine the beam with a best signal-to-interference ratio (SINR);
indicating, by each MS, an index of the beam with the best SINR to enable the BS to perform the grouping.

3. The method of claim 1, wherein each ABF zone includes an up link (UL) compressed map to indicate locations of subsequent UL ranging region in an UL subframe, there being one UL ranging region for each beam.

4. The method of claim 1, wherein the BS transmits using each zone at a different time.

5. The method of claim 4, wherein the network included a set of the BS, each BS associated with one set of MS, wherein the set of BS transmit to the sets of active MS in adjacent parts of adjacent cells at different times to reduce interference among the sets of active MS.

6. The method of claim 1, wherein the transmitting BS, using the zones is at random times.

7. The method of claim 1, wherein the MS only detect the preambles in the beams that are adjacent to the beam currently used for receiving the DL subframe.

8. The method of claim 1, wherein the detecting is performed periodically.

9. The method of claim 8, wherein a time interval between performing the detecting is on an order of seconds.

10. The method of claim 8, wherein the detecting is repeated only when the MS moves.

11. The method of claim 3, further comprising:
transmitting ranging signals using the ranging regions periodically.

12. The method of claim 3, further comprising:
transmitting a channel quality indication for different beams for all subchannels.
